(19) United States
(12) Patent Application Publication
(10) Pub. No.: US 2015/0332677 A1
(43) Pub. Date: Nov. 19, 2015

(54) AUDIO CODEC MODE SELECTOR

(71) Applicant: Nokia Technologies Oy, Espoo (FI)

(72) Inventors: Adriana VASILACHE, Tampere (FI); Lasse Juhani LAAKSONEN, Tampere (FI); Anssi Sakari RÄMÖ, Tampere (FI)

(21) Appl. No.: 14/710,284

(22) Filed: May 12, 2015

(30) Foreign Application Priority Data
May 15, 2014 (GB) 1408606.0

(51) Int. Cl. G10L 19/002; G10L 19/02

(52) U.S. Cl. CPC G10L 19/002; G10L 19/02

(57) ABSTRACT

There is inter alia a method comprising: receiving a request to change the coding rate of a multimode audio codec; determining that the request corresponds to a coding rate of another mode of operation of the multimode audio codec; determining a frame of an input audio signal of the multimode audio codec to be an active region of the audio signal; maintaining a current operating mode of the multimode audio codec; and reducing the coding rate of the multimode audio codec to a coding rate lower than the requested coding rate.

### FIELD

The present application relates to a codec mode switching mechanism for a multi-mode audio signal encoder, and in particular, but not exclusively to a codec mode switching mechanism for a multi-mode audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise).

An audio codec can also be configured to operate with varying bit rates. At lower bit rates, such an audio codec may be optimized to work with speech signals at a coding rate equivalent to a pure speech codec. At higher bit rates, the audio codec may code any signal including music, background noise and speech, with higher quality and performance. A variable-rate audio codec can also implement an embedded scalable coding structure and bitstream, where additional bits (a specific amount of bits is often referred to as a layer) improve the coding upon lower rates, and where the bitstream of a higher rate may be truncated to obtain the bitstream of a lower rate coding. Such an audio codec may utilize a codec designed purely for speech signals as the core layer or lowest bit rate coding.

An audio codec can also adopt a multimode approach for encoding the input audio signal, in which a particular mode of coding is selected according to the format of the input audio signal.

Audio codecs which are configured to operate as a multimode and/or variable bit rate codec may be arranged to switch the coding mode or bit rate at the granularity of an audio coding frame. In other words the coding mode or the bit rate may be switched with the frequency of the audio coding frame rate, on a frame by frame basis.

However, having the capability to switching between different codec modes with such frequency can result in unwanted artefacts being introduced into the encoded audio signal. This effect may be especially prevalent during those regions of the speech or audio signal with have a high energy level, in other words the so called active regions.

### SUMMARY

There is provided according to an aspect of the application a method comprising: receiving a request to change the coding rate of a multimode audio codec; determining that the request corresponds to a coding rate of another mode of operation of the multimode audio codec; determining a frame of an input audio signal of the multimode audio codec to be an active region of the audio signal; maintaining a current operating mode of the multimode audio codec; and reducing the coding rate of the multimode audio codec to a coding rate lower than the requested coding rate.

The method may further comprise determining that a weighting function is below a predetermined threshold.

The weighting function may be a measure of the perceptual degradation of reducing the coding rate of the multimode audio codec to a coding rate lower than the requested coding rate.

The weighting function may be an accumulative weighting function, and wherein the weighting function may accumulate on a frame by frame basis of the input audio signal.

The weighting function may accumulate by adding an audio signal type dependent weighting value and a coding rate dependency penalty factor to the weighting function on the frame by frame basis.

The multimode audio codec may comprise a plurality of audio codecs, and a mode of operation of the multimode audio codec may correspond to the operation of an audio codec of the plurality of audio codecs.

Each of the plurality of audio codecs of the multimode audio codec may each operate at one of a plurality of coding rates.

The coding rate lower than the requested coding rate may comprise the highest coding rate of the plurality of coding rates which is lower than the requested coding rate.

The request to change the coding rate of the multimode audio codec may be in response to a change in a transmission bandwidth.

According to a further aspect of the application there is provided an apparatus configured to: receive a request to change the coding rate of a multimode audio codec; determine that the request corresponds to a coding rate of another mode of operation of the multimode audio codec; determine a frame of an input audio signal of the multimode audio codec to be an active region of the audio signal; maintain a current operating mode of the multimode audio codec; and reduce the coding rate of the multimode audio codec to a coding rate lower than the requested coding rate.

The apparatus may be further configured to determine that a weighting function is below a predetermined threshold.

The weighting function may be a measure of the perceptual degradation in an encoded audio signal of reducing the coding rate of the multimode audio codec to a coding rate lower than the requested coding rate.

The weighting function may be an accumulative weighting function, and the weighting function may accumulate on a frame by frame basis of the input audio signal.

The weighting function may accumulate by adding an audio signal type dependent weighting value and a coding rate dependency penalty factor to the weighting function on the frame by frame basis.

The multimode audio codec may comprise a plurality of audio codecs, and a mode of operation of the multimode audio codec may correspond to the operation of an audio codec of the plurality of audio codecs.

Each of the plurality of audio codecs of the multimode audio codec can each operate at one of a plurality of coding rates.

The coding rate lower than the requested coding rate may comprise a highest coding rate of the plurality of coding rates which is lower than the requested coding rate.

The request to change the coding rate of the multimode audio codec may be in response to a change in a transmission bandwidth.

According to another aspect of the application there is provided an apparatus comprising at least one processor and at least one memory including computer code, the at least one memory and the computer code configured to with the at least one processor cause the apparatus to: receive a request to change the coding rate of a multimode audio codec; determine that the request corresponds to a coding rate of another mode of operation of the multimode audio codec; determine a frame of an input audio signal of the multimode audio codec to be an active region of the audio signal; maintain a current operating mode of the multimode audio codec; and reduce the coding rate of the multimode audio codec to a coding rate lower than the requested coding rate.

The apparatus may be further caused to determine that a weighting function is below a predetermined threshold.

The weighting function may be a measure of the perceptual degradation of reducing the coding rate of the multimode audio codec to a coding rate lower than the requested coding rate.

The weighting function may be an accumulative weighting function, and the weighting function may accumulate on a frame by frame basis of the input audio signal.

The weighting function may accumulate by adding an audio signal type dependent weighting value and a coding rate dependency penalty factor to the weighting function on the frame by frame basis.

The multimode audio codec may comprise a plurality of audio codecs, and a mode of operation of the multimode audio codec may correspond to the operation of an audio codec of the plurality of audio codecs.

Each of the plurality of audio codecs of the multimode audio codec may each operate at one of a plurality of coding rates.

The coding rate which is lower than the requested coding rate may comprise a highest coding rate of the plurality of coding rates which is lower than the requested coding rate.

The request to change the coding rate of the multimode audio codec may be in response to a change in a transmission bandwidth.

A computer program comprising instructions that when executed by a computer apparatus perform the method as described herein.

According to yet another aspect of the application there is provided a non-transitory computer-readable storage medium having stored thereon computer-readable code, which, when executed by computing apparatus, causes the computing apparatus to: receive a request to change the coding rate of a multimode audio codec; determine that the request corresponds to a coding rate of another mode of operation of the multimode audio codec; determine a frame of an input audio signal of the multimode audio codec to be an active region of the audio signal; maintain a current operating mode of the multimode audio codec; and reduce the coding rate of the multimode audio codec to a coding rate lower than the requested coding rate.

### BRIEF DESCRIPTION OF DRAWINGS

For better understanding of the present application and as to how the same may be carried into effect, reference will now be made by way of example to the accompanying drawings in which:

FIG. 1 shows schematically an electronic device employing some embodiments;

FIG. 2 shows schematically an audio codec system according to some embodiments;

FIG. 3 shows schematically a multimode audio signal encoder as shown in FIG. 2 according to some embodiments;

FIG. 4 shows schematically example combined coding rates for a first audio encoder and a second audio encoder of multimode audio signal encoder shown in FIG. 3 according to some embodiments; and

FIG. 5 shows a flow diagram illustrating the operation of the encoding mode selector shown in FIG. 3 according to some embodiments.

### DESCRIPTION OF SOME EMBODIMENTS

The following describes in more detail possible codec mode switching mechanisms for multimode audio coders.

Multimode audio codecs can seamlessly switch between one operating mode and another by informing the corresponding multimode audio decoder the mode of coding. However, mode switching in multimode audio codecs may be constrained to take place during certain regions of an audio signal. This may be attributed to the fact that each mode of the multimode audio codec may use a different coding technology to encode the audio signal, and therefore it may not be possible to maintain the encoding continuity when transitioning from one coding technology to another. The consequence of switching between one coding technology and another may be the introduction of annoying artefacts in the encoded audio signal. Typically this effect may be minimised in multimode codec systems by constraining mode switches to occur during low energy or inactive regions of the speech/audio signal.

However, when a multimode coding system is constrained to only allow switching between codec modes during certain regions of the audio/speech coding system, the multimode coding system may be unable to switch coding modes at the most opportune moment in terms of coding quality or operational bit rate.

The concept as described herein may proceed from the aspect that in order for a multimode coding system to operate in an optimal manner it is preferable that any constraints when a switch in coding mode is allowed is kept to a minimum.

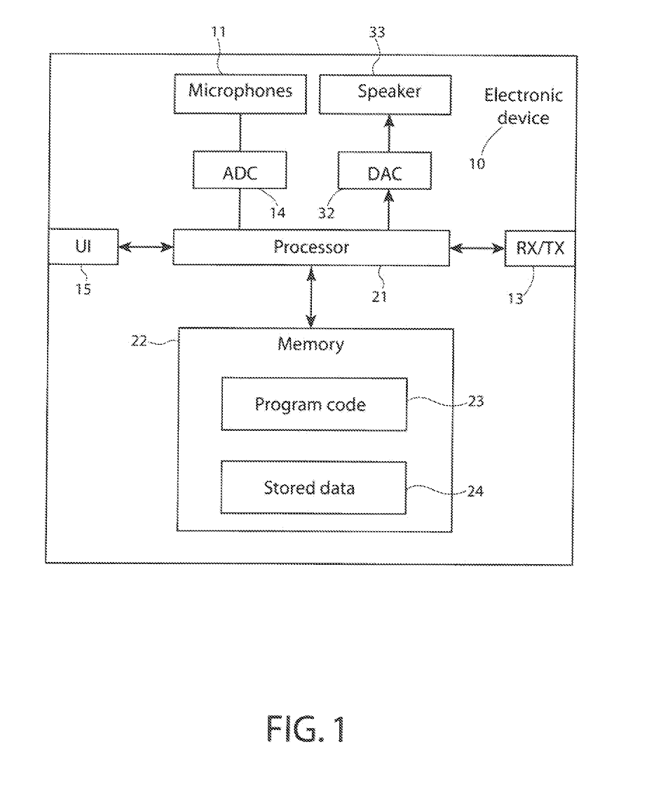

In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise a multichannel or stereo encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

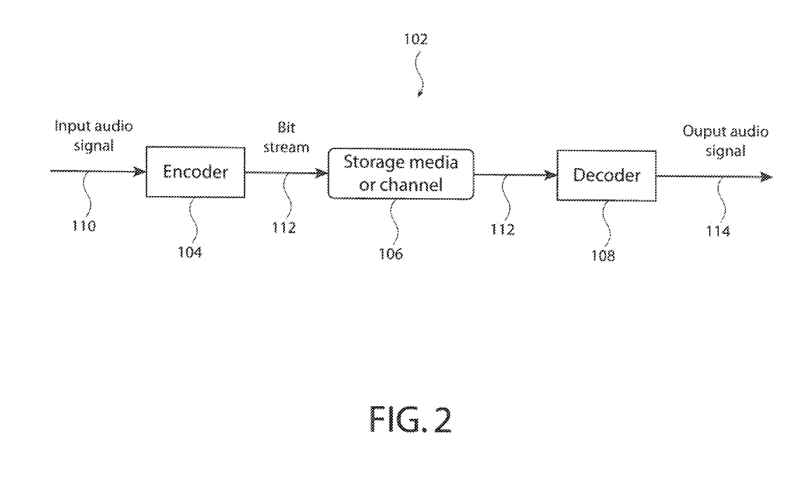

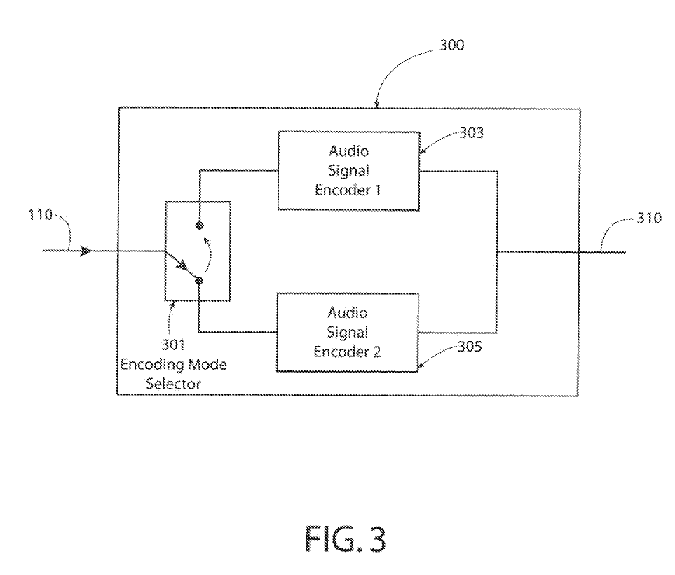

The processor 21 in such embodiments then processes the digital audio signal in the same way as described with reference to the system shown in FIG. 2 and the encoder shown in FIG. 3.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

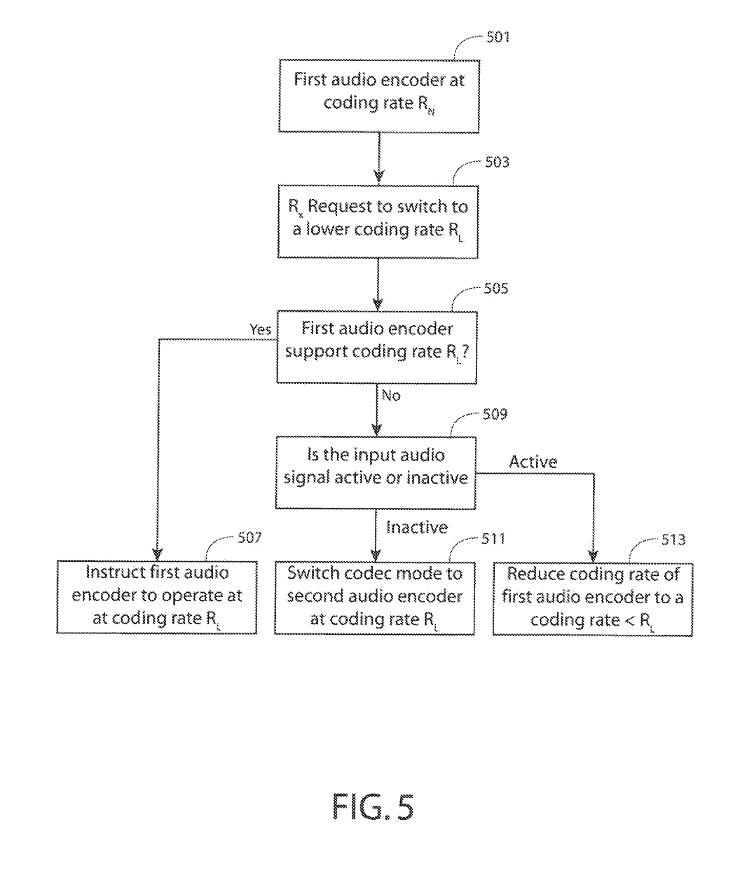

It would be appreciated that the schematic structures described in FIGS. 1 to 3, and the method steps shown in FIG. 5 represent only a part of the operation of an audio codec and specifically part of a multimode encoder apparatus or method as exemplarily shown implemented in the apparatus shown in FIG. 1.

The general operation of audio codecs as employed by embodiments is shown in FIG. 2. General audio coding/decoding systems comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104 and in particular a multichannel audio signal encoder, a storage or media channel 106 and a decoder 108. It would be understood that as described above some embodiments can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise a multichannel encoder 151 as part of the overall encoding operation. It is to be understood that the multichannel encoder may be part of the overall encoder 104 or a separate encoding module.

The bit stream 112 can be received within the decoder 108. The decoder 108 decompresses the bit stream 112 and produces an output audio signal 114. The decoder 108 can comprise a multichannel decoder as part of the overall decoding operation. It is to be understood that the multichannel decoder may be part of the overall decoder 108 or a separate decoding module. The bit rate of the bit stream 112 and the quality of the output audio signal 114 in relation to the input signal 110 are the main features which define the performance of the coding system 102.

FIG. 3 shows schematically the encoder 104 according to some embodiments.

The concept for the embodiments as described herein is to encode the input audio signal using a multimode audio signal encoder in which the mode of coding can be switched depending on factors such as the type of audio signal being encoded or the available bandwidth. Furthermore, the multimode audio signal encoder can be arranged to encode input audio/speech signals of various types such as a stereo audio signal, or more generally a multichannel audio signal. The resulting encoded audio parameters can then be packaged for transmission over the media channel 106. To that respect FIG. 3 shows a multimode audio signal encoder 300, an example of an encoder 104 according to some embodiments. Furthermore with respect to FIG. 5 the operation of at least part of the multimode audio signal encoder 300 is shown in further detail.

The encoder 104 in some embodiments comprises a multimode audio signal encoder 300. The multimode audio signal encoder 300 can be configured to receive an audio signal 110 and generate an encoded audio signal 310. The multimode audio signal encoder 300 may be configured to receive either mono or multichannel audio signals and encode the signal accordingly. For example, the audio signal encoder 300 may be arranged to receive a multi-channel audio signal with a left and a right channel, such as a stereo or binaural signal.

The multimode audio signal encoder 300 may have the capability of encoding the input audio signal using any one of a plurality of different modes of encoding. In some embodiments each mode of encoding may each be realised as a particular and distinct type coding technology. In other words the multimode audio signal encoder 300 may comprise a number of different audio codecs with each audio codec being a mode of encoding.

In other embodiments each mode of encoding may be realised as a set of configurable options based on a single uniform coding technology. For example, a first mode of encoding may be based on the same coding technology as a further mode of encoding. However the difference between the first mode coding and the further mode of encoding may be a difference in the number of encoded parameters which are common to both modes of encoding, for example a difference in the number of encoded spectral components.

With reference to FIG. 3 the multimode audio signal encoder 300 is depicted as comprising two audio signal encoders 303 and 305, and the selection between a first mode of encoding (audio signal encoder 303) and a second mode of encoding (audio signal encoder 305) is controlled by the encoding mode selector 301.

It is to be understood that FIG. 3 depicts a multimode audio signal encoder 300 comprising two modes of operation which are depicted schematically as audio signal encoder 1 303 and audio signal encoder 2 305. However, it is to be appreciated that other embodiments may deploy further encoding modes arranged as further audio signal encoders, and as such the encoding mode selector 301 may be arranged to select between each of the further encoding modes.

The multimode audio signal encoder 300 in FIG. 3 is shown as receiving the input audio signal 110 via the encoding mode selector 301. The encoding mode selector 301 may then analyse the input audio signal 110 in conjunction with any system bandwidth requirements in order to determine whether audio signal encoder 1 303 or audio signal encoder 2 305 should be selected to encode the input audio signal 110.

In a first group of embodiments each audio signal encoder within the multimode audio signal encoder 300 may each be arranged to work at a number of different coding rates. The range of coding rates supported by each audio signal encoder may overlap.

For example in the first group of embodiments the first audio signal encoder 303 of the multimode audio signal encoder 300 may be capable of operating at any one of N coding rates, which may be seen as spanning a range of coding rates from R_{A1} to R_{AN}, where A signifies the first audio signal encoder 303. The second audio signal encoder 305 of the multimode audio signal encoder 300 may be capable of operating at any one of M coding rates, which may be seen as spanning a range of coding rates from R_{B1} to R_{BN}, where B signifies the second audio signal encoder 305.

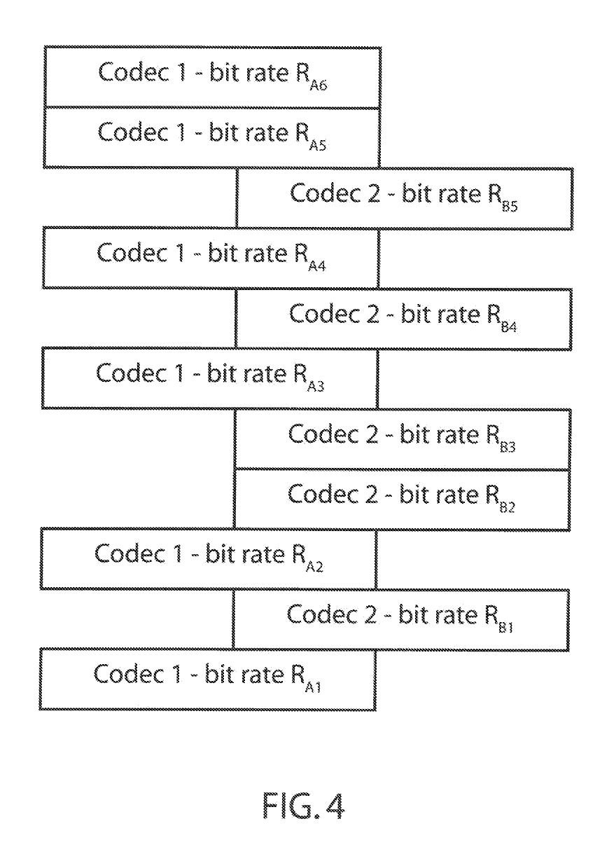

With reference to FIG. 4 there is shown a visual depiction of an illustration of an example of a range of coding rates for the first audio signal encoder 303 and the second audio signal encoder 305 of the multimode audio signal encoder 300. In this illustrative example the first audio signal encoder 303 comprises six allowable coding rates with R_{A1} being the lowest coding rate and R_{A6} being the highest coding rate, and the second audio signal encoder 305 comprises five allowable coding rates from R_{B1} to R_{B5}.

FIG. 4 also depicts the range of allowable coding rates when the coding rates of the first audio signal encoder 303 are combined with the coding rates of the second audio signal encoder 305. In this illustrative example of the first group of embodiments it can be seen that the lowest overall combined coding rate is R_{A1} and the highest overall combined coding rate is R_{A6}.

In the first group of embodiments the encoding mode selector 301 can be configured to select any of the allowable coding rates from each of the audio signal encoders 303 and 305. For example, in the illustrative example of the first group of embodiments the encoding mode selector 301 can be arranged to select any of the coding rates from the combined set of coding rates R_{A1} to R_{A6} and R_{B1} to R_{B5}.

During the operation of the multimode audio signal encoder 300, the multimode audio signal encoder 300 may be configured to operate at a particular coding rate by the audio mode selector 301 by the encoding mode selector 301 determining the encoding mode which supports the required (or target) coding rate. The audio mode selector 301 may then select the audio signal encoder which has been determined to support the required coding rate to encode the input audio signal 110.

The encoding mode selector 301 may also be configured to receive a request for a change in the required (target) coding rate. In some circumstances this request may require a change in the operational encoding mode of the multimode audio signal encoder 300. For instance this may occur when the newly requested target coding rate is not supported by the currently operating audio signal encoder. In other words the encoding mode selector 301 may cause the multimode audio signal encoder 300 to switch from one audio signal encoder to another audio signal encoder in order that the multimode audio encoder 300 encodes the input audio signal at the newly required (or target) coding rate. Once again it is to be appreciated that in this context that a change in the audio signal encoder is a change in the operating mode of the multimode audio signal encoder 300.

It is to be understood that in this context a change in the operational mode of the multimode audio encoder results in the transition from one audio signal encoder to another audio signal encoder.

The encoding mode selector 301 may also be tasked with determining whether a change in the operational mode of the multimode audio signal encoder 300 would occur during an active audio/speech frame. If it is determined that there is required to be a change in the operating mode of the multimode audio signal encoder 300 and the transition between codec modes will occur during an active audio/speech frame, the encoding mode selector 301 may be arranged to maintain the multimode audio signal encoder 300 in its current operational mode and instruct the currently operating audio encoder to operate at a bit rate which is lower than the newly requested (or target) coding rate. If on the other hand, it is determined by the encoding mode selector 301 that the transition between codec modes may occur during an inactive frame or region of the input audio/speech signal, then the encoding mode selector 301 may cause the multimode audio signal encoder 300 to switch to an audio signal encoder which supports the required (or target) coding rate.

Ensuring that there is only a transition in the coding mode during inactive or low energy regions of the input audio/speech signal has the advantage of avoiding annoying artefacts being introduced into the encoded audio signal.

It is to be understood, that a change in the coding rate may be instigated by a change in the transmission bandwidth of the system. Therefore in order to meet any newly imposed bandwidth requirements it may be necessary to operate the multimode audio signal encoder 300 in an existing operational mode and at a lower coding rate, particularly if a change in the coding mode would require an audio codec transition during an active region of the input audio signal.

With reference to FIG. 5 there is shown a flow diagram depicting in more detail the operation of the encoding mode selector 301.

Initially FIG. 5, depicts the processing step 501 whereby a first audio encoder 303 of the multimode audio encoder 300 is operating at a particular coding rate. In a non-limiting example, the first audio encoder 303 may for instance be operating at the initial coding rate of R_{A6}.

The audio codec mode selector 301 may then receive a request for the multimode audio signal codec 300 to operate at a lower coding rate. As explained above the request may be due to a reduction in the available transmission bandwidth. For example, the request may for instance indicate that the multimode audio signal codec 300 should change its coding rate from R_{A6} to the lower coding rate of R_{B5}.

The receiving of the request to switch to a lower coding rate is shown as processing step 503 in FIG. 5.

The encoding mode selector 301 may then first determine whether there is a need to switch coding modes in order to meet the newly requested lower coding rate. In other words, the encoding mode selector 301 may determine whether the newly requested coding rate is supported within the current coding mode of the multimode audio signal encoder 300. If it is determined that the current coding mode of the multimode audio signal encoder 300 supports the new required coding rate, the encoding mode selector 301 may simply instruct the currently operating audio encoder to switch to the newly requested coding rate.

The step of determining whether the newly requested coding rate is supported by the currently operating audio encoder is shown as processing step 505, and the step of instructing the currently operating audio encoder to switch to the newly requested coding rate is shown as processing step 507 in FIG. 5

However, if it is determined at processing step 505 that the current operating audio encoder does not support the newly requested coding rate. The encoding mode selector 301 may then determine that the new requested coding rate is supported by another coding mode of the multimode audio signal encoder 300, and in this instance the audio codec mode selector 301 may then determine that a switch to the other coding mode should be made.

However, before a switch in coding mode is performed it is first determined by the encoding mode selector 301 whether the switch will be made either during a region of the input signal 110 of inactive audio/speech or during a region of the input signal of active audio/speech.

The step of determining whether the input audio/speech signal will be either active or inactive during any change of coding modes is shown as processing step 509 in FIG. 5.

If the encoding mode selector 301 determines at processing step 509 that the input audio/speech signal is in an inactive region, then audio mode selector 301 may instigate a switch in coding modes in the multimode audio signal encoder 300. The switch in coding modes may cause the multimode audio encoder 300 to operate at the newly requested coding rate within another coding mode of the multimode audio signal encoder 300.

For example, the coding mode selector 301 may cause the coding mode multimode audio encoder 300 to change from the first audio encoder 301 operating at the coding rate of R_{A6} to the second audio encoder 305 operate at the coding rate of R_{B5}.

The step of causing the multimode audio encoder 300 to switch to another mode or encoding at the newly requested coding rate is shown as the processing step 511 in FIG. 5.

On the other hand, if it is determined at the processing step 509 that the input/speech signal is in an active region, the encoding mode selector 301 may not instigate a switch in coding modes. Instead, the encoding mode selector 301 may instruct the current audio encoder to drop to a coding rate lower than the newly requested coding rate. This may be done in part in order to satisfy any bandwidth transmission constraints.

In a first group of embodiments the encoding mode selector 301 may instruct the current audio encoder to drop to a coding rate which satisfies the condition that the reduced coding rate is a coding rate of the first audio codec which is closest to the requested coding rate, whilst also being below the requested coding rate.

For example in the instance the encoding mode selector 301 cause the first audio encoder 303 to reduce its coding rate, the first audio encoder 303 may be instructed by the encoding mode selector 301 to reduce the coding rate R_{A6} to R_{A4}. In other words, the first audio encoder 303 is being instructed by the encoding mode selector 301 to reduce its coding rate to below requested coding rate of R_{B5}.

The step of reducing the coding rate of the current operating audio encoder within the multimode audio signal encoder 300 in response to a newly requested coding rate is shown as processing step 513 in FIG. 5.

In some embodiments the multimode audio signal encoder 300 may encode the input audio signal with the first audio encoder operating at a reduced coding rate until a subsequent inactive region of the input audio signal occurs. At this point the audio mode selector 301 may then cause the multimode audio signal encoder 300 to switch to the coding mode which supports the requested coding rate. In other words in terms of the above non limiting example the encoding mode selector 301 may cause the multimode audio signal encoder 300 to switch to the second audio codec 305 with the coding rate of R_{B5} during a subsequent inactive region.

In further embodiments the decision step 509 as performed by the encoding mode selector 301 may be further enhanced by the addition of a weighting function or metric. This weighting function may be deployed by the encoding mode selector 301 for the situation when a change in a coding rate results in the current coding mode being maintained and the corresponding coding rate of the being reduced to a level below that of the requested coding rate. In other words the weighting function may be deployed when the request to change the coding rate would result in a change to the encoding mode but is prevented from doing so due to the input audio signal 110 being active.

The weighting function may be arranged such that after a number of audio frames a change in coding mode may be forced despite the audio signal continuing to remain in an active state. Therefore causing the multimode audio signal encoder 300 to operate at the requested coding rate.

In order to accommodate the weighting function and achieve the above functionality, the decision logic of 509 may be arranged such that the current coding mode of the multimode audio signal encoder 301 can be maintained whilst operating at a lower coding rate when the combined conditions exist of the next audio input signal frame being active and the weighting function is below a predetermined threshold.

In the further embodiments the combined audio signal activity and weighting function decision logic of decision 509 may be illustrated in terms of the above non limiting example as steps 3 and 4 below.
1. Codec running at bit rate RA₅ (Codec 1)
2. Switch request to bit rate RB₄ (Codec 2)
3. Detect signal activity (and evaluate signal type) in next frame
4. If (signal is active AND F_{SWITCH}<NO_CORE_SWITCH_{TH} AND bit rate is not R_{B4})
   Maintain current codec and switch to next lower allowed rate RA₃ (Codec 1)
5. Else
   Switch to RB₄ as requested (Codec 2), and ‘end’
6. If bit rate RB₄ was not achieved, try again in next frame

Whereby F_{switch} is an adaptive weighting function and NO_CORE_SWITCH_{TH} is the predetermine threshold to which the adaptive weighting function F_{switch} is compared.

In the further embodiments the adaptive weighting function F_{switch} may be arranged to measure the accumulated perceptual degradation due to coding the input audio signal at a coding rate which is lower than the requested coding rate. In other words the weighting function is a measure of the perceptual degradation in the encoded audio signal of reducing the coding rate of the multimode audio signal codec 300 to a coding rate lower than the requested coding rate.

The accumulative effect of the adaptive weighting function F_{switch} may be updated for each input audio signal frame in which the multimode audio signal encoder 300 operates at a coding rate lower than the requested coding rate.

In the further embodiments the adaptive weighting function may be expressed as

F_{switch}(i)=F_{switch}(i−1)+W_{sigtype}(i)*P_{NO}_{_{switch}}(i),

where F_{switch}(i) is the accumulated adaptive weighting function for the ith frame after a coding rate change request which causes the multimode audio signal codec 300 to maintain the current mode of coding whilst operating at a coding rate lower than the requested coding rate, F_{switch}(i−1) is the accumulated weighting function for the previous frame after the coding rate change request, and where W_{sigtype}(i) and P_{NO}_{_{switch}}(i) are respectively a signal type dependent weighting value and rate depending penalty factor for the frame i.

It is to be appreciated in embodiments that the adaptive weighting function F_{switch}(i) can be set to zero at the time of the request for a change in coding rate. The adaptive weighting function will then accumulate on an input audio signal frame by frame basis until either there is a new request for a change in the coding rate of the multimode audio signal encoder 300 or the requested (target) coding rate is achieved.

Therefore it is to be understood in the situation that the requested coding rate would require a change in the encoding mode of the multimode audio signal encoder 300 and the next frame of the input audio signal is classified as inactive, then the requested (or target) coding rate of the multimode audio signal encoder 300 will be achieved and the adaptive weighting function would reset to zero during the encoding to the next frame. In other words in this situation when the coding rate change request can be met during the course of the subsequent audio input frame the adaptive weighting function does not actually accumulate a value and remains at zero.

In some embodiments an audio signal encoder associated with a particular mode of encoding of the multimode audio signal encoder 300 may comprises a frame sectioner/transformer which can be configured to section or segment the audio signal sections or frames suitable for frequency domain transformation. The frame sectioner/transformer can further be configured to window these frames or sections of audio signal data from each channel of the multichannel audio signal with any suitable windowing function. For example a frame sectioner/transformer can be configured to generate frames of 20 ms which may overlap preceding and succeeding frames by 10 ms each.

The frame sectioner/transformer can be configured to perform any suitable time to frequency domain transformation on the audio signals from each of the input channels. For example the time to frequency domain transformation can be a Discrete Fourier Transform (DFT), Fast Fourier Transform (FFT) and Modified Discrete Cosine Transform (MDCT). In the following examples a FFT is used. Furthermore the output of the time to frequency domain transformer can be further processed to generate separate frequency band domain representations (sub-band representations) of each input channel audio signal data. These bands can be arranged in any suitable manner. For example these bands can be linearly spaced, or be perceptual or psychoacoustically allocated.

The multimode audio signal encoder 300 can comprise a relative audio energy signal level determiner which may be arranged to determine relative audio signal levels or interaural level (energy) difference (ILD) between pairs of channels for each sub band from the frequency band domain representations. The relative audio signal level for a sub band may be determined by finding an audio signal level in a frequency band of a first audio channel signal relative to an audio signal level in a corresponding frequency band of a second audio channel signal.

Any suitable interaural level (energy) difference (ILD) estimation can be performed. For example for each frame there can be two windows for which the delay and levels are estimated. Thus for example where each frame is 10 ms there may be two windows which may overlap and are delayed from each other by 5 ms. In other words for each frame there can be determined two separate level difference values which can be passed to the encoder for encoding. The differences for each window can be estimated for each of the relevant sub bands. The division of sub-bands can be determined according to any suitable method.

For example the sub-band division which in turn determines the number of interaural level (energy) difference (ILD) estimation can be performed according to a selected bandwidth determination. For example the generation of audio signals can be based on whether the output signal is considered to be wideband (WB), superwideband (SWB), or fullband (FB) (where the bandwidth requirement increases in order from wideband to fullband). For the possible bandwidth selections there can in some embodiments be a particular division in subbands.

The multimode audio signal encoder 300 can comprise a channel analyser/mono encoder which can be configured to analyse the frequency domain representations of the input multi-channel audio signal and determine parameters associated with each sub-band with respect to bi-channel or multi-channel audio signal differences.

The multimode audio signal encoder 300 can comprises a multi-channel parameter encoding unit for coding and quantizing the multi-channel audio signal differences. These encoded and quantized multi-channel audio signal differences can be referred to as multichannel extensions, or in the case of a stereo input signal the bi-channel audio signal differences can be referred to as stereo extensions.

Parameters associated with each sub band of the multi-channel audio signal can be down mixed in order to generate a mono channel which can be encoded according to any suitable encoding scheme.

The generated mono channel audio signal (or reduced number of channels encoded signal) can be encoded using any suitable encoding format. For example the mono channel audio signal can be encoded using an Enhanced Voice service (EVS) mono channel encoded form. The encoded mono channel audio signal can also be referred to as the core codec encoded signal.

The output from the multichannel audio signal encoder 300 may then be connected by a connection to the input of a payload formatter along which the encoded audio signal 310 may be conveyed.

The audio payload formatter 303 may be arranged to form a suitable payload format which may at least form part of an audio bitstream 112 for transmission over a suitable communication channel 106.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths. Furthermore, it is to be understood that the coding modes and their associated bit rates of FIG. 4 are exemplary, and the codec may be configured to implement another set of coding modes.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. Method comprising:
receiving a request to change the coding rate of a multimode audio codec;
determining that the request corresponds to a coding rate of another mode of operation of the multimode audio codec;
determining a frame of an input audio signal of the multimode audio codec to be an active region of the audio signal;
maintaining a current operating mode of the multimode audio codec; and
reducing the coding rate of the multimode audio codec to a coding rate lower than the requested coding rate.

2. The method as claimed in claim 1, wherein the method further comprises
determining that a weighting function is below a predetermined threshold.

3. The method as claimed in claim 2, wherein the weighting function is a measure of the perceptual degradation in an encoded audio of reducing the coding rate of the multimode audio codec to a coding rate lower than the requested coding rate.

4. The method as claimed in claim 2, wherein the weighting function is an accumulative weighting function, and wherein the weighting function accumulates on a frame by frame basis of the input audio signal.

5. The method as claimed in claim 4, wherein the weighting function accumulates by adding an audio signal type dependent weighting value and a coding rate dependency penalty factor to the weighting function on the frame by frame basis.

6. The method as claimed in claim 1, wherein the multimode audio codec comprises a plurality of audio codecs, and wherein a mode of operation of the multimode audio codec corresponds to the operation of an audio codec of the plurality of audio codecs.

7. The method as claimed in claim 1, wherein each of the plurality of audio codecs of the multimode audio codec each operate at one of a plurality of coding rates.

8. The method as claimed in claim 7, wherein the coding rate lower than the requested coding rate comprises a highest coding rate of the plurality of coding rates which is lower than the requested coding rate.

9. The method as claimed in claim 1, wherein the request to change the coding rate of the multimode audio codec is in response to a change in a transmission bandwidth.

10. An apparatus comprising at least one processor and at least one memory including computer code, the at least one memory and the computer code configured to with the at least one processor cause the apparatus to: receive a request to change the coding rate of a multimode audio codec;
determine that the request corresponds to a coding rate of another mode of operation of the multimode audio codec;
determine a frame of an input audio signal of the multimode audio codec to be an active region of the audio signal;
maintain a current operating mode of the multimode audio codec; and
reduce the coding rate of the multimode audio codec to a coding rate lower than the requested coding rate.

11. The apparatus as claimed in claim 10, wherein the apparatus is further caused to:
determine that a weighting function is below a predetermined threshold.

12. The apparatus as claimed in claim 11, wherein the weighting function is a measure of the perceptual degradation in an encoded audio signal of reducing the coding rate of the multimode audio codec to a coding rate lower than the requested coding rate.

13. The apparatus as claimed in claim 11, wherein the weighting function is an accumulative weighting function, and wherein the weighting function accumulates on a frame by frame basis of the input audio signal.

14. The apparatus as claimed in claim 13, wherein the weighting function accumulates by adding an audio signal type dependent weighting value and a coding rate dependency penalty factor to the weighting function on the frame by frame basis.

15. The apparatus as claimed in claim 10, wherein the multimode audio codec comprises a plurality of audio codecs, and wherein a mode of operation of the multimode audio codec corresponds to the operation of an audio codec of the plurality of audio codecs.

16. The apparatus as claimed in claim 10, wherein each of the plurality of audio codecs of the multimode audio codec each operate at one of a plurality of coding rates.

17. The apparatus as claimed in claim 16, wherein the coding rate lower than the requested coding rate comprises a highest coding rate of the plurality of coding rates which is lower than the requested coding rate.

18. The apparatus as claimed in claim 10, wherein the request to change the coding rate of the multimode audio codec is in response to a change in a transmission bandwidth.

19. A non-transitory computer-readable storage medium having stored thereon computer-readable code, which, when executed by computing apparatus, causes the computing apparatus to:
receive a request to change the coding rate of a multimode audio codec;
determine that the request corresponds to a coding rate of another mode of operation of the multimode audio codec;
determine a frame of an input audio signal of the multimode audio codec to be an active region of the audio signal;
maintain a current operating mode of the multimode audio codec; and
reduce the coding rate of the multimode audio codec to a coding rate lower than the requested coding rate.
